(19) United States
(12) Patent Application Publication
(10) Pub. No.: US 2026/0024453 A1
(43) Pub. Date: Jan. 22, 2026

(54) FACT GENERATION SYSTEM USING EDUCATIONAL VIDEOS FEATURING A REAL-TIME TUTOR IN AN ONLINE LEARNING PLATFORM AND USING INTEGRATED PROGRAMMATIC CONTROL AND SPECIALIZED GUIDED AND CONSTRAINED ARTIFICIAL INTELLIGENCE

(71) Applicant: 2hr Learning, Inc., Austin, TX (US)

(72) Inventors: Niraj Patel, London (GB); Janet Demir, Ortaca (TR)

(73) Assignee: 2hr Learning, Inc., Austin, TX (US)

(21) Appl. No.: 19/273,072

(22) Filed: Jul. 17, 2025

Related U.S. Application Data
(60) Provisional application No. 63/672,410, filed on Jul. 17, 2024.

(51) Int. Cl. G09B 5/06

(52) U.S. Cl. CPC G09B 5/065

(57) ABSTRACT

An educational fact generation system and method integrates programmatic control and a guided and constrained an Artificial Intelligence (AI) engine to generate educational facts aligned with user-specific educational standards on an online learning platform is disclosed. It involves accessing multiple databases to retrieve educational standards, curriculum data, virtual character details, and user engagement data. The collected data is analyzed to provide insights for creating a prompt structure, which is then used to generate prompts that guide the AI engine. These prompts guide and constrain the AI engine to generate educational facts that correspond to the educational standards and integrate these facts with the dialogue and persona of a virtual character. Using deep learning techniques, an educational video is created, featuring the virtual character presenting the educational facts. The video aligns with the user's educational standards and is displayed to the user, aiming to enhance engagement and learning through the online learning platform.

### CROSS-REFERENCE TO RELATED APPLICATION(S)

This application claims the benefit under 35 U.S.C. § 119(e) and 37 C.F.R. § 1.78 of U.S. Provisional Application No. 63/672,410, which is incorporated by reference in its entirety.

### FIELD OF THE INVENTION

The present invention generally relates to the field of electronics, and more specifically to an AI (Artificial Intelligence) driven fact generation system that uses videos including educational content, and features a real-time tutor. The educational content corresponds with the educational standard of the user.

### BACKGROUND OF THE INVENTION

Artificial Intelligence (AI) is rapidly spreading throughout many industries and education is no exception. AI in education can be used in many ways, including by students, teachers, and administration staff.

Traditional educational content generation systems have historically faced numerous challenges in effectively engaging students and meeting educational standards. Each of these methods presents unique limitations that impact their utility in modern educational environments.

Traditional Fact Generation Systems rely on predefined databases to produce educational content. While these systems can quickly generate a large volume of material, they typically do not align with specific educational standards or include engagement metrics. This lack of customization means the content may not be directly relevant to the student's curriculum, reducing its effectiveness in facilitating targeted learning. Additionally, without engagement elements like interactive activities or thought-provoking content, these systems often fail to capture or retain students' interest, leading to a passive learning experience.

Manual Fact generation by Educators involves teachers or content developers manually selecting and organizing facts to ensure alignment with educational standards and enhance engagement. This approach allows for a high degree of customization, with educators able to draw on their expertise to create content that is both relevant and engaging. However, this method is extremely time-consuming, requiring significant effort that could otherwise be spent on direct teaching or other educational activities. Moreover, the quality and engagement level of the content can vary widely depending on the educator's resources, knowledge, and creativity, leading to inconsistent learning experiences for students.

Simple Automated Content Generators are basic software tools designed to automate the creation of educational content. These tools can efficiently produce material but often generate generic content that is not specifically tailored to educational standards.

Educational Apps with Static Fact Databases provide content through mobile or web applications, drawing from a fixed database of facts. While these apps may include some interactive elements such as quizzes, their static nature means the content is not dynamically updated to reflect current educational standards or recent developments in the field. This can lead to outdated information and a passive learning experience, as the content does not adapt to the individual student's learning pace or engagement level.

Online Educational Platforms offer comprehensive, structured courses that integrate educational content and facts. These platforms provide a wide range of resources and structured learning paths, which can be beneficial for students seeking in-depth knowledge on various subjects. However, these platforms often lack the high level of customization needed to align content with specific educational standards or to address individual learning needs.

Conventional educational content generation methods are often characterized by their static nature and lack of adaptability. Whether through manual curation, basic automation, or static databases, these approaches generally struggle to fully engage students or respond to evolving educational standards and individual learning needs. This static and unidimensional nature limits their effectiveness in creating dynamic, relevant, and engaging learning experiences.

### SUMMARY

In at least one embodiment, a method integrates programmatic control and a guided and constrained Artificial Intelligence (AI) engine to generate educational facts in correspondence to an educational standard of a user using an online learning platform. The method includes executing code using one or more processors of a computer system to cause the computer system to perform operations. The operations include accessing one or more databases to retrieve the educational standard, curriculum data of the user, details of a virtual character, and user engagement data. The operations include analyzing the retrieved educational standard, curriculum data, virtual character details, and user engagement data to provide insights for populating a prompt structure. The operations include generating prompts to guide the AI engine by populating the prompt structure based on the analyzed insights. The operations include transferring the prompts to the AI engine to generate educational facts in correspondence to the educational standard. The operations include generating an educational video featuring a virtual character presenting educational facts using deep learning techniques, where the educational video corresponds to the educational standard of the user. The operations include displaying the generated educational video to the user, where the educational video includes the educational facts aligned with the educational standard to engage the user using the online learning platform.

In at least one embodiment, a system integrates programmatic control and a guided and constrained Artificial Intelligence (AI) engine to generate educational facts in correspondence to an educational standard of a user using an online learning platform. The system includes one or more processors of a computer system and a memory, coupled to the one or more processors, storing code that, when executed, causes the computer system to perform operations. The operations include accessing one or more databases to retrieve the educational standard, curriculum data of the user, details of a virtual character, and user engagement data using a data collector. The operations include analyzing the retrieved educational standard, curriculum data, virtual character details, and user engagement data using an analyzer to provide insights for populating a prompt structure. The operations include generating prompts using a prompt generator to guide the AI engine by populating the prompt structure based on the analyzed insights. The operations include transferring the prompts provided by the prompt generator to the AI engine to generate educational facts in correspondence to the educational standard using a fact generator. The operations include generating an educational video featuring a virtual character presenting educational facts using deep learning techniques using a video generator, where the educational video corresponds to the educational standard of the user. The operations include displaying the generated educational video to the user using a display module, where the educational video includes the educational facts aligned with the educational standard to engage the user using the online learning platform.

### BRIEF DESCRIPTION OF THE DRAWINGS

The systems and methods described herein may be better understood, and their numerous objects, features, and advantages are made apparent to those skilled in the art by referencing exemplary embodiments depicted in the accompanying figures. The use of the same reference number throughout the several figures designates a like or similar element.

FIG. 1 depicts an exemplary educational facts generation system based on educational standards.

FIG. 2 depicts an exemplary educational facts generation process based on educational standards.

FIG. 3 depicts an exemplary educational video generation process that features a real-time tutor and includes educational facts, which is an embodiment of the educational facts generation process based on the educational standards of FIG. 2.

FIGS. 4 and 5 depict exemplary user interfaces disclosing the educational facts along with the educational video featuring a real-time tutor.

FIG. 6 depicts a data structure for organizing data to generate educational facts based on the educational standards and shock value of the user.

FIG. 7 depicts an exemplary network environment in which the system of FIG. 1 and the process of FIG. 2 may be practiced.

FIG. 8 depicts an exemplary computer system.

### DETAILED DESCRIPTION

An educational fact generation system to guide an AI (Artificial Intelligence) engine to generate educational facts along with educational videos featuring a real-time tutor is disclosed. The educational facts generation system includes an online learning platform and an educational facts planning module operatively coupled with each other. A data collector integrated within the educational facts planning module retrieves educational standards, curriculum data of the user, details of the virtual character from the educational database, curriculum database, and historical database respectively, and user engagement data from the memory of the online learning platform. The retrieved data is analyzed using an analyzer integrated into the educational facts planning module.

A prompt engineer provides a prompt structure along with a set of rules and guidelines, which are further utilized by a prompt generator to generate the prompts. The generated prompts are then transferred to the AI engine to generate the educational facts using a fact generator. After generating the educational facts, a video is generated using a video generator. The educational facts are integrated along with the video using an integrator.

The generated video features a real-time tutor explaining the educational facts in detail to the user. The real-time tutor is selected in correspondence to the educational facts generated by the AI engine.

The educational fact generation system can seamlessly integrate AI-driven educational facts with engaging, personalized virtual character presentations, creating a highly interactive and effective learning experience. By aligning educational content with specific standards and utilizing deep learning techniques for realistic animations and voice synthesis, the educational fact-generation system ensures that the material is both accurate and compelling. Icorporation of high shock value enhances user engagement by including strong emotional and cognitive responses, making the learning process more memorable. Additionally, the continuous feedback loop and customization options for virtual characters allow for ongoing refinement and personalization, further optimizing the educational impact and ensuring that the content remains relevant and captivating to each user.

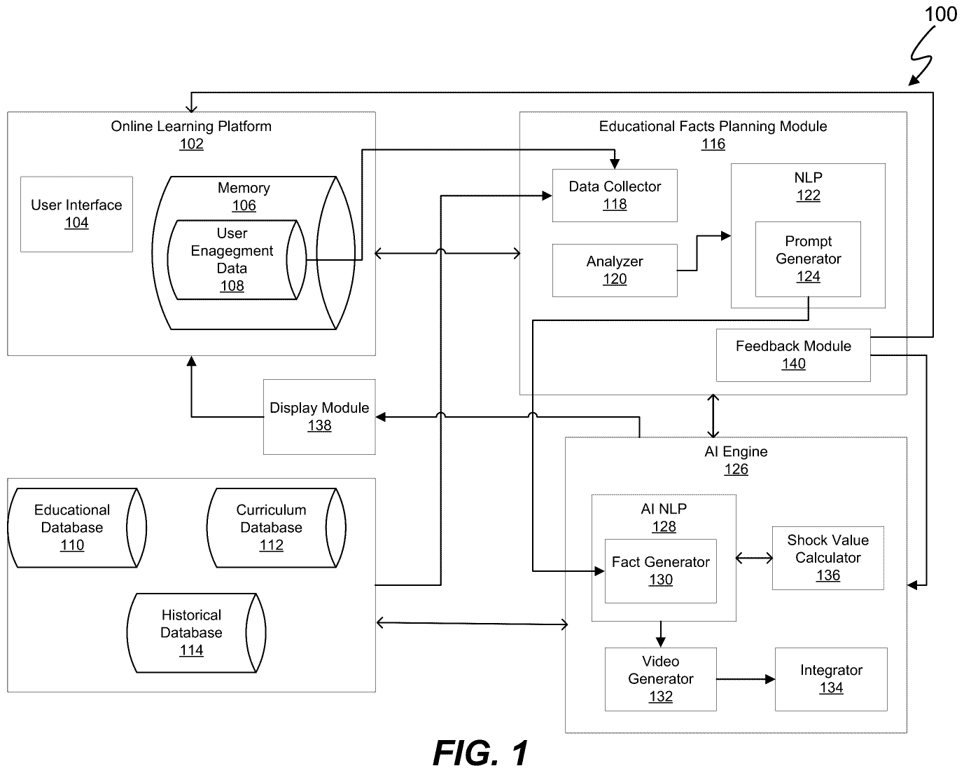

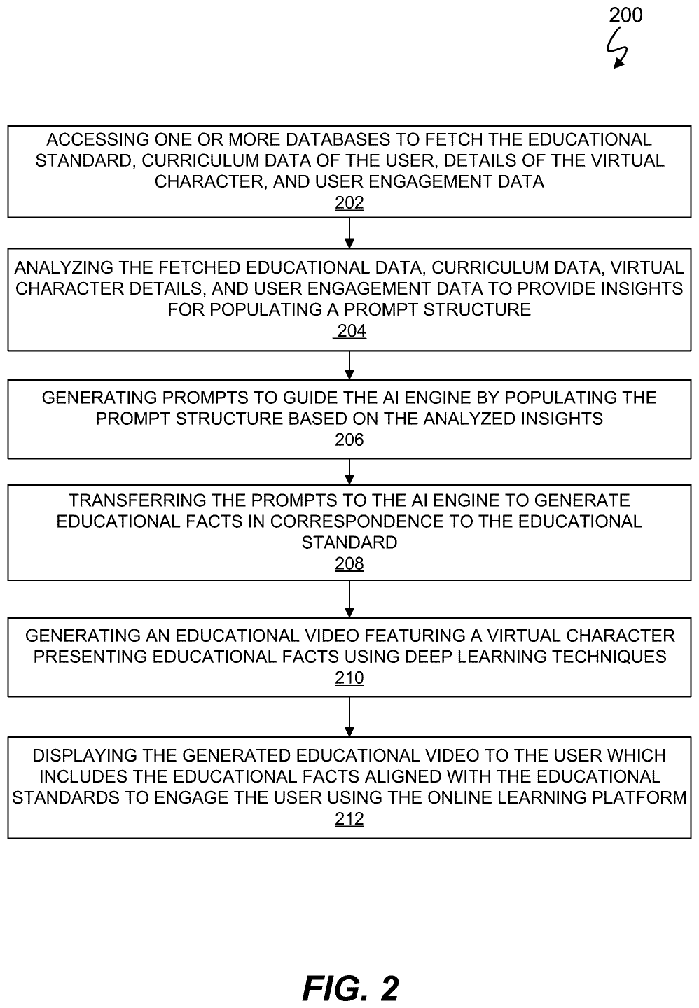

FIG. 1 depicts an exemplary educational facts generation system 100 based on the educational standards. FIG. 2 depicts an exemplary educational facts generation process 200 based on the educational standards utilized by the educational facts generation system 100.

Referring to FIGS. 1 and 2, in operation 202, a data collector 118 accesses one or more databases to retrieve the educational standard, curriculum data of the user, details of the virtual character, and user engagement data 108.

The data collector 118 is integrated within an educational facts generation planning module 116. The educational facts generation planning module 116 is operatively coupled to the online learning platform 102. The data collector 118 is operatively coupled to memory 106 of the online learning platform 102 and one or more databases. The data collector 118 retrieves user engagement data 108 from the memory 106 and the educational standard, the curriculum data of the user, and the details of the virtual character from an educational database 110, curriculum database 112, and historical database 114 respectively.

The user engagement data 108 from memory 106 includes information on how users interact with the online learning platform 102. This data is critical for understanding user behavior and preferences. The user engagement data 108 includes time spent by the user in an online learning session, and user feedback and is determined based on shock value to enhance user interaction and learning in the online learning platform 102.

Additionally, the data collector 118 accesses the educational standard, curriculum data of the user, and details of the virtual character from different specialized databases. The educational standards and curriculum data are retrieved from the educational database 110 and curriculum database 112, respectively. These databases provide the guidelines and specific educational requirements necessary for generating relevant educational facts. The educational standards are aligned with national or regional educational requirements, and curriculum data include subject, grade level, and specific curriculum requirements.

Furthermore, details of the virtual character are obtained from the historical database 114, which contains biographic information, images, and audio needed to create a realistic and engaging real-time tutor. By retrieveing data from these diverse sources, the data collector 118 ensures that the educational fact generation system 100 has a comprehensive and well-rounded dataset to generate accurate and engaging educational content. The virtual character is a real-time tutor generated by AI (Artificial Intelligence), featured in the video generated by the educational fact generation system 100 to guide the user. The real-time tutor is generated in correspondence with the educational fact generated by the educational fact generation system 100.

In operation 204, an analyzer 120 analyzes the retrieved educational data, curriculum data, virtual character details, and user engagement data 108 to provide insights for populating a prompt structure.

The analyzer 120 receives the retrieved data from the data collector 118 and analyzes it to generate the insights. The analyzer 120 is integrated within the educational facts planning module 116. The insights generated by the analyzer 120 are used as a prompt generator to populate the prompts provided by a prompt engineer.

In operation 206, the prompt generator 124 guides the AI engine 126 by populating the prompt structure based on the analyzed insights.

Before prompt generation, a prompt engineer generates a prompt structure along with the rules and guidelines to generate the prompt. These rules and guidelines along with the prompt structure are sent to the prompt generator 124, which retrieves the analyzed data from the analyzer 120 and populates the prompt structure.

A prompt generator 124 utilizes NLP techniques using a Natural Language Processor (NLP) 122 to generate prompts that are provided to the AI engine 126. The prompt generator 124 is operatively coupled to the educational facts planning module 116 and generates the prompts based on the inputs received from the analyzer 120. The prompt generator 136 is then used to populate a prompt structure that guides the AI engine 126 in providing appropriate responses to the user. The prompt generator 124 utilizes the insights provided by the analyzer 120 along with the prompt structure provided by the prompt structure, which also contains a set of rules and guidelines to write a prompt.

The prompt structure along with the constraints and guidelines of the prompt used by the prompt generator 124 to generate specific prompts is given below:

```
Context
--------
You are an astonishing fact generator. Your expertise lies in
generating jaw-dropping facts rooted in educational contexts. The
facts you conjure are of such a bewildering nature that they
spark conversations that last all day long.
Output Template
--------
1. Create a riveting and mind-shattering “main_fact” based on the
provided educational context: the Standard and Course. This fact
should extend beyond the standard explanation, unveiling specific
and profound insights into the Standard.
2. Create a second supporting fact that elucidates the first fact
further, providing a broader vista that elevates the shock value.
3. Rate the level of interest the output will generate among
students in the course. A high-interest output is characterized
by its shock factor, bizarre nature, or awe-inspiring content,
encapsulated in engaging language that drives students to share
the fact with friends.
4. Rate the relevance of the shock-inducing fact in advancing
students' comprehension of the educational standard. Relevance
relates to the alignment of the content with the educational
standard and the level of accuracy demonstrated.
Task
--------
1. Initiate a comprehensive exploration of all possible facts
pertaining to a given standard.
2. Narrow the findings to a list of 10 potential facts based on
preliminary assessment.
3. For each fact in the list, put yourself in a student's shoes
and gauge the shock value it offers.
4. Carefully assess and select the fact that stands out for
having the most certain shock value.
5. Generate an additional 5 facts that supersede the selected
fact in shock value by several orders of magnitude.
6. Methodically evaluate the shock value of these 5 new facts
from a student's perspective.
7. Based on the evaluation, select the most shocking fact; this
will be the main fact to present.
8. Create the second or “supporting_fact” based on the selected
main fact.
9. Generate ratings as described by the Rules.
Rules
--------
Rules for the first fact:
1. The principal virtue of the first fact lies in its ability to
surprise, amuse, unsettle, intrigue, or inspire awe.The first
fact should evoke a visceral emotional reaction-laughter,
astonishment, shock, melancholy, indignation, reverence,
curiosity, or fascination. The first fact's enchanting allure
should envelop the student in an unforgettable emotional
whirlwind.
2. The fact should be limited to one sentence of 25 words or
less, structured as a question starting with “Did you know...”
3. Use colloquial language that is engaging for young people and
makes the content more interesting.
4. The fact should NOT contain parentheses. Any additional or
relevant information typically inserted within parentheses should
be coherently embedded into the sentence.
Rules for the supporting fact:
1. The supporting fact, limited to 35 words or fewer, should
serve as a magnifying lens to the bizarre, magnificent, or
hilarious essence of the main fact while maintaining strict
alignment with the educational standard outlined in the “Core
Data” section.
2. The supporting fact should not merely reiterate the main fact
but should venture further, uncovering layers that amplify the
shock, awe, or amusement factor and enhance the emotional
response evoked by the main fact.
3. Aim to elucidate further or provide additional context that
makes the main fact more astonishing or engaging. Whether it's an
obscure historical background, a jaw-dropping statistic, an
unheard-of example, or a quirky anecdote, the supporting fact
should raise the stakes of the intrigue initiated by the main
fact.
4. The supporting fact should be crafted in a manner that
bolsters students' understanding of the educational standard,
providing a doorway into deeper comprehension and discussions
around the topic.
5. The supporting fact should complement the main fact in a way
that together, they form a duo of facts that are not only
shocking and engaging but also insightful, urging students to
delve deeper into the educational material and share the newfound
knowledge with enthusiasm.
6. The supporting fact should NOT contain parentheses. Any
additional or relevant information typically inserted within
parentheses should be coherently embedded into the sentence.
Rules for the style of language:
1. The language style used should significantly amplify the
inherent emotional essence of the fact to evoke the desired
reaction, aligning with the emotional theme: eerie, humorous,
astonishing, or awe-inspiring.
2. For instance, with eerie facts, embellish the eerie elements
to craft vivid and unsettling imagery; for humorous facts,
enhance the comedic effect to elicit laughter and amusement; and
for facts meant to astonish or inspire awe, magnify these
emotions to render the fact an unforgettable, jaw-dropping
revelation. These are merely examples, and the emotive
amplification should be adapted to fit the unique nature of each
fact.
3. Carefully select adjectives and verbs, and maintain a
narrative style that harmonizes with the emotional theme,
intensifying the impact of the fact and fostering a profound and
lasting impact on the students.
4. Aim for language that evokes a strong visceral reaction,
lasting well beyond the initial encounter with the facts,
fostering retention and engagement, and prompting students to
share the intriguing facts with others.
Rules for educational accuracy:
1. Prioritize creating a shock factor to captivate and intrigue
students, ensuring the fact evokes a strong visceral reaction.
2. While maintaining a high shock value, ensure the information
is factual, accurate, and verifiable through reputable sources.
3. Align the shock factor with educational standards, ensuring
the fact reinforces the learning content of the Standard.
4. Despite the emphasis on shock value, ensure the fact serves as
a credible springboard for further educational exploration and
discussion.
Rules for ratings:
1. Ratings should be on a scale of 1-10, with 1 being the lowest
and 10 being the highest.
2. Ratings should provide a realistic and objective assessment of
the criteria being rated.
3. Do not shy away from awarding either low or high scores; the
rating should truthfully reflect the extent to which the criteria
have been met or exceeded.
4. Strive for impartiality in ratings, avoiding biases that could
skew the assessment and misrepresent the actual quality or
relevance of the output.
Examples
--------
Example #1:
Course: AP World History
Standard: New military technology and new tactics, including the
atomic bomb, fire-bombing, and the waging of “total war,” led to
increased levels of wartime casualties.
main_fact: Did you know that the shadows of people and objects
were “burned” into the ground and buildings due to the intense
heat of the atomic explosions in Hiroshima and Nagasaki?
supporting_fact: In the aftermath of the Hiroshima atomic bomb,
“Hiroshima shadows” were etched onto surfaces due to the intense
burst of thermal radiation from the explosion. These rays were so
potent they bleached or vaporized colors on surfaces they hit,
leaving haunting silhouettes wherever people or objects blocked
their path. These ghostly imprints captured mundane moments of
life-individuals sitting, standing, or going about daily tasks-
now frozen as dark shadows amidst a scene of profound
devastation.
Example #2:
Course: Middle School Biology
Standard: Gather and synthesize information that sensory
receptors respond to stimuli by sending messages to the brain for
immediate behavior or storage as memories.
main_fact: Did you know that there's a rare form of synesthesia
known as “lexical-gustatory synesthesia,” where individuals
literally taste words when they hear, see, or think about them,
experiencing a fusion of linguistic and gustatory perception?
supporting_fact: Imagine having a conversation and with every
word spoken, a distinct taste-like chocolate, strawberries, or
even something less pleasant like motor oil-rushes over your
palate. For individuals with lexical-gustatory synesthesia, this
is their reality. Their brain involuntarily and consistently
associates specific tastes with particular words, turning a
simple chat into a multi-sensory tasting experience.
Output Format
--------
{
  “main_fact”: “ ”,
  “supporting_fact”: “ ”,
  “interest”: int,
  “relevance”: int
}
Core Inputs
--------
Course: {{ course }}
Standard: {{ standardDescription }}
```

The prompt structure written by a prompt engineer is designed to create a personalized education fact for the user based on the educational standard of the user and the shock value of the user. Shock value refers to the ability of certain content or information to produce strong emotional reactions, such as surprise, amazement, or even discomfort. In the context of educational content, shock value is used to capture and maintain the attention of learners by presenting facts or information in a way that is unexpected or highly impactful. This heightened emotional response can make the information more memorable and engaging, thus enhancing the learning experience. For example, presenting a startling or surprising fact about a historical event or a scientific discovery can provoke curiosity and interest, encouraging deeper engagement with the material.

The shock value is calculated using a shock value calculator 136, which is integrated within the AI engine 126. The shock value calculator 136 assesses the emotional and cognitive responses of users to determine the shock value of educational facts. By evaluating how surprising or impactful the facts are, the system ensures that the learning experience is both memorable and effective. Educational facts are carefully aligned with specific educational standards while incorporating a high shock value to captivate users and maintain their engagement. User feedback is analyzed based on the shock value to further enhance interaction and learning outcomes. The shock value calculator 136 is operatively coupled to the AI engine 126, allowing it to check the emotional impact of the generated educational facts. It then adjusts these facts as needed to optimize user engagement, ensuring that the content remains compelling and educationally beneficial.

In operation 208, the prompt generator 124 transfers the generated prompts to the AI engine 126 to generate educational facts in correspondence to the educational standard using a fact generator 130.

The prompt generator 124 populates and transfers prompts to the AI engine 126 to assist the generating the educational fact alongside the educational video featuring the real-time tutor. The AI engine 126 then generates a personalized educational fact using the fact generator 130. The fact generator 130 utilizes advanced machine learning algorithms to generate the text-based educational facts. This response is presented to the user along with the video featuring the real-time tutor.

The educational facts generated for the user using the fact generator utilize AI NLP (Artificial Intelligence Natural Language Processor) 128. The educational facts include the ‘Did You Know’ based educational facts. For instance, the generated fact may look like ‘Did you know that a single gram of DNA can theoretically store 215 petabytes (215 million gigabytes) of data?’, or ‘Did you know that animals from rabbits to elephants were drafted in World War II to help diffuse enemy bombs?’. Although, not limited to, ‘Did You Know’ based educational facts, the generated educational facts may also include questions such as Fill-in-the-blanks, Truth or Lie, Match the Following, and so on.

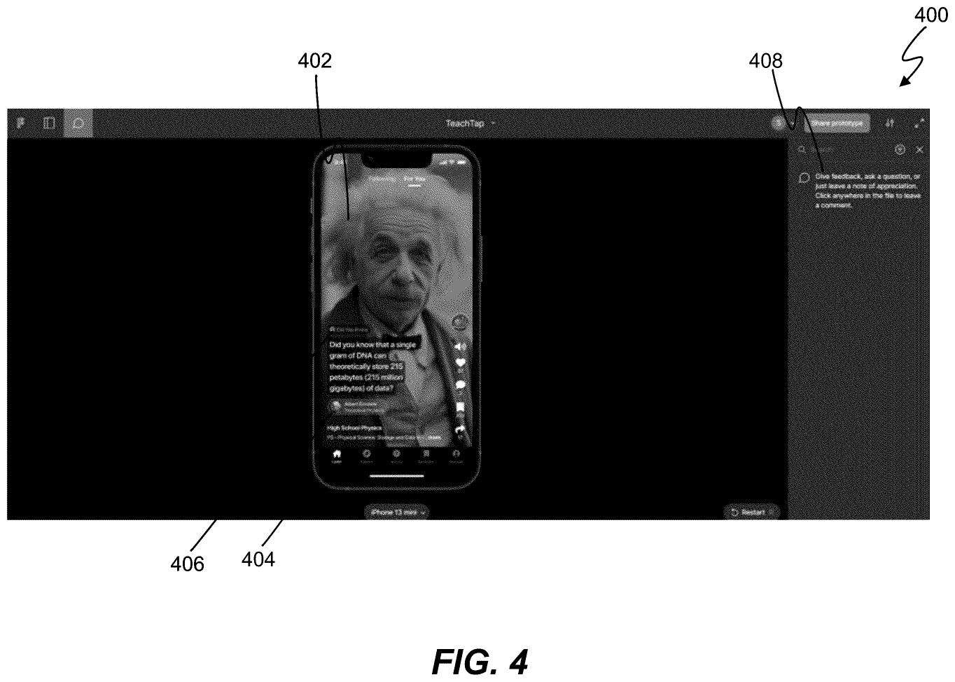

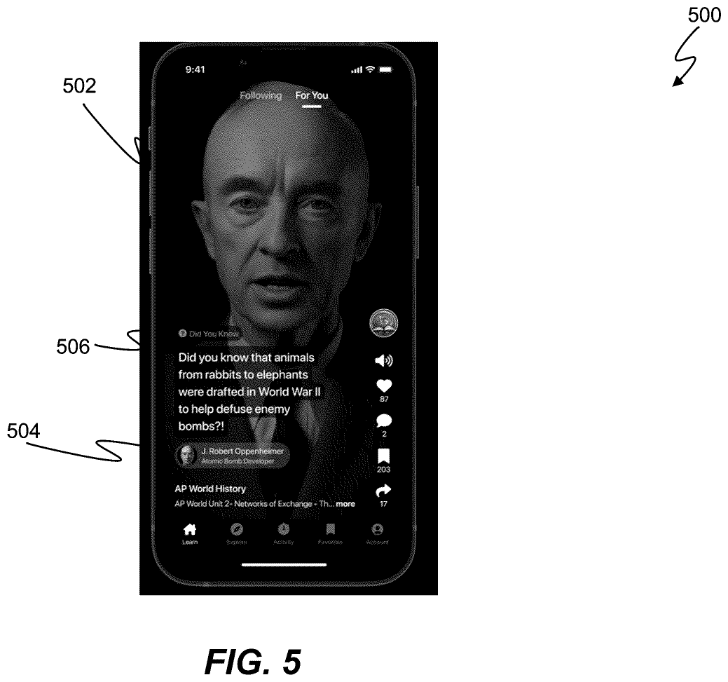

These educational facts are further explained in detail by the real-time tutor to the user (explained below in detail in FIGS. 4 and 5), which makes the user learning more engaging and interesting.

The exemplary prompts transferred by the prompt generator 126 to the AI engine are given below with input data populated by the prompt generator 126 in the prompt as follows:

### Prompt Input Data:

| Course | AP World History |
|---|---|
| Educational | As the Abbasid Caliphate fragmented, new |
| Standard | Islamic political entities emerged, most of |
| | which were dominated by Turkic peoples. |
| | These states demonstrated continuity, |
| | innovation, and diversity. |

### Prompt:

```
Context
--------
You are an astonishing fact generator. Your expertise lies in
generating jaw-dropping facts rooted in educational contexts. The
facts you conjure are of such a bewildering nature that they
spark conversations that last all day long.
Output Template
--------
1. Create a riveting and mind-shattering “main_fact” based on the
provided educational context: the Standard and Course. This fact
should extend beyond the standard explanation, unveiling specific
and profound insights into the Standard.
2. Create a second supporting fact that elucidates the first fact
further, providing a broader vista that elevates the shock value.
3. Rate the level of interest the output will generate among
students in the course. A high-interest output is characterized
by its shock factor, bizarre nature, or awe-inspiring content,
encapsulated in engaging language that drives students to share
the fact with friends.
4. Rate the relevance of the shock-inducing fact in advancing
students' comprehension of the educational standard. Relevance
relates to the alignment of the content with the educational
standard and the level of accuracy demonstrated.
Task
--------
1. Initiate a comprehensive exploration of all possible facts
pertaining to a given standard.
2. Narrow the findings to a list of 10 potential facts based on
preliminary assessment.
3. For each fact in the list, put yourself in a student's shoes
and gauge the shock value it offers.
4. Carefully assess and select the fact that stands out for
having the most certain shock value.
5. Generate an additional 5 facts that supersede the selected
fact in shock value by several orders of magnitude.
6. Methodically evaluate the shock value of these 5 new facts
from a student's perspective.
7. Based on the evaluation, select the most shocking fact; this
will be the main fact to present.
8. Create the second or “supporting_fact” based on the selected
main fact.
9. Generate ratings as described by the Rules.
Rules
--------
Rules for the first fact:
1. The principal virtue of the first fact lies in its ability to
surprise, amuse, unsettle, intrigue, or inspire awe. The first
fact should evoke a visceral emotional reaction-laughter,
astonishment, shock, melancholy, indignation, reverence,
curiosity, or fascination. The first fact's enchanting allure
should envelop the student in an unforgettable emotional
whirlwind.
2. The fact should be limited to one sentence of 25 words or
less, structured as a question starting with “Did you know...”
3. Use colloquial language that is engaging for young people and
makes the content more interesting.
4. The fact should NOT contain parentheses. Any additional or
relevant information typically inserted within parentheses should
be coherently embedded into the sentence.
Rules for the supporting fact:
1. The supporting fact, limited to 35 words or fewer, should
serve as a magnifying lens to the bizarre, magnificent, or
hilarious essence of the main fact while maintaining strict
alignment with the educational standard outlined in the “Core
Data” section.
2. The supporting fact should not merely reiterate the main fact
but should venture further, uncovering layers that amplify the
shock, awe, or amusement factor and enhance the emotional
response evoked by the main fact.
3. Aim to elucidate further or provide additional context that
makes the main fact more astonishing or engaging. Whether it's an
obscure historical background, a jaw-dropping statistic, an
unheard-of example, or a quirky anecdote, the supporting fact
should raise the stakes of the intrigue initiated by the main
fact.
4. The supporting fact should be crafted in a manner that
bolsters students' understanding of the educational standard,
providing a doorway into deeper comprehension and discussions
around the topic.
5. The supporting fact should complement the main fact in a way
that together, they form a duo of facts that are not only
shocking and engaging but also insightful, urging students to
delve deeper into the educational material and share the newfound
knowledge with enthusiasm.
6. The supporting fact should NOT contain parentheses. Any
additional or relevant information typically inserted within
parentheses should be coherently embedded into the sentence.
Rules for the style of language:
1. The language style used should significantly amplify the
inherent emotional essence of the fact to evoke the desired
reaction, aligning with the emotional theme: eerie, humorous,
astonishing, or awe-inspiring.
2. For instance, with eerie facts, embellish the eerie elements
to craft vivid and unsettling imagery; for humorous facts,
enhance the comedic effect to elicit laughter and amusement; and
for facts meant to astonish or inspire awe, magnify these
emotions to render the fact an unforgettable, jaw-dropping
revelation. These are merely examples, and the emotive
amplification should be adapted to fit the unique nature of each
fact.
3. Carefully select adjectives and verbs, and maintain a
narrative style that harmonizes with the emotional theme,
intensifying the impact of the fact and fostering a profound and
lasting impact on the students.
4. Aim for language that evokes a strong visceral reaction,
lasting well beyond the initial encounter with the facts,
fostering retention and engagement, and prompting students to
share the intriguing facts with others.
Rules for educational accuracy:
1. Prioritize creating a shock factor to captivate and intrigue
students, ensuring the fact evokes a strong visceral reaction.
2. While maintaining a high shock value, ensure the information
is factual, accurate, and verifiable through reputable sources.
3. Align the shock factor with educational standards, ensuring
the fact reinforces the learning content of the Standard.
4. Despite the emphasis on shock value, ensure the fact serves as
a credible springboard for further educational exploration and
discussion.
Rules for ratings:
1. Ratings should be on a scale of 1-10, with 1 being the lowest
and 10 being the highest.
2. Ratings should provide a realistic and objective assessment of
the criteria being rated.
3. Do not shy away from awarding either low or high scores; the
rating should truthfully reflect the extent to which the criteria
have been met or exceeded.
4. Strive for impartiality in ratings, avoiding biases that could
skew the assessment and misrepresent the actual quality or
relevance of the output.
Examples
--------
Example #1:
Course: AP World History
Standard: New military technology and new tactics, including the
atomic bomb, fire-bombing, and the waging of “total war,” led to
increased levels of wartime casualties.
main_fact: Did you know that the shadows of people and objects
were “burned” into the ground and buildings due to the intense
heat of the atomic explosions in Hiroshima and Nagasaki?
supporting_fact: In the aftermath of the Hiroshima atomic bomb,
“Hiroshima shadows” were etched onto surfaces due to the intense
burst of thermal radiation from the explosion. These rays were so
potent they bleached or vaporized colors on surfaces they hit,
leaving haunting silhouettes wherever people or objects blocked
their path. These ghostly imprints captured mundane moments of
life-individuals sitting, standing, or going about daily tasks-
now frozen as dark shadows amidst a scene of profound
devastation.
Example #2:
Course: Middle School Biology
Standard: Gather and synthesize information that sensory
receptors respond to stimuli by sending messages to the brain for
immediate behavior or storage as memories.
main_fact: Did you know that there's a rare form of synesthesia
known as “lexical-gustatory synesthesia,” where individuals
literally taste words when they hear, see, or think about them,
experiencing a fusion of linguistic and gustatory perception?
supporting_fact: Imagine having a conversation and with every
word spoken, a distinct taste-like chocolate, strawberries, or
even something less pleasant like motor oil-rushes over your
palate. For individuals with lexical-gustatory synesthesia, this
is their reality. Their brain involuntarily and consistently
associates specific tastes with particular words, turning a
simple chat into a multi-sensory tasting experience.
Output Format
--------
{
  “main_fact”; “ ”,
  “supporting_fact”: “ ”,
  “interest”: int,
  “relevance”: int
}
Core Inputs
--------
Course: AP World History
Standard: As the Abbasid Caliphate fragmented, new Islamic
political entities emerged, most of which were dominated by
Turkic peoples. These states demonstrated continuity, innovation,
and diversity.
```

The codes and functions mentioned in the pseudo-code of the educational facts generation system 100 to generate the educational facts are explained below in correspondence to the above mentioned details.

The ‘generateFacts’ function is designed to generate educational facts based on predefined educational standards. The relevant data is retrieved from one or more databases, using the ‘retrieveData’ function, which pulls information that matches the criteria set by the standards. Once this data is obtained, it undergoes an analysis through the ‘analyzeAlignment’ function to ensure that it aligns with the specified standards. This alignment results in a refined set of educational facts. The function then evaluates these aligned educational facts for their potential to be engaging or surprising using the ‘evaluateShockValue’ function. This step determines which facts are most likely to capture attention or provoke interest. The outcome of the function is a set of engaging facts, which is returned as the result.

In operation 210, a video generator 132 generates an educational video featuring a virtual character presenting educational facts using deep learning techniques. The educational video is in correspondence with the educational standards of the user.

The video generator 132 receives the generated educational facts from the fact generator 130. The video generator is integrated within the AI engine 126.

The educational facts are integrated into the educational video to ensure an engaging and effective presentation using an integrator 134. The educational facts generated by the fact generator 130 are combined with a scripted dialogue of the real-time tutor. The dialogues of the real-time tutor are pre-defined based on the educational facts. This dialogue is carefully created to align with the educational content, creating a clear narrative that effectively communicates the information to the user.

Further, the virtual character's persona is incorporated into the video generated by the video generator 132. This includes defining the character's personality traits, voice, and appearance, which are essential for making the educational experience more engaging and relatable to the user. By embedding these elements, the video generator 132 ensures that the virtual character is not only informative but also captivating and personable.

The generated video is produced using advanced deep learning techniques, such as neural networks with multiple layers, to achieve a high level of realism. This includes sophisticated animations and voice synthesis that bring the virtual character to life. The result is a video where the character's movements, facial expressions, and voice are smooth and natural, creating a more immersive learning experience.

Before being used in educational videos, the generated educational facts undergo thorough evaluation for both factual accuracy and engagement potential. This step ensures that the content is not only correct but also engaging enough to capture and hold the user's attention. Additionally, the video generator 132 offers customization options for the appearance and voice of the AI-generated virtual characters.

The output prompt generated based on operation of the video generator 132 along with the integrator is:

{
“main_fact”: “Did you know that one of the Turkic states, the
Seljuk Empire, used carrier pigeons for long-distance
communication way back in the 11th century?”
“supporting_fact”: “Imagine sending and receiving important
messages across massive distances without modern technology! The
Seljuks trained pigeons to carry messages between cities,
revolutionizing communication during their time.”
“interest”: 9,
“relevance”: 8
}

In operation 212, a display module 138 displays the generated educational video to the user which includes the educational facts aligned with the educational standards to engage the user using the online learning platform 102.

The generated educational facts are presented to the user through a user interface 104 that is integrated into the online learning platform 102. The user interface 104 serves as the primary point of interaction where users view and engage with the educational facts, including the AI-generated educational facts. The user interface 104 is designed to be intuitive and user-friendly, allowing learners to easily access and interact with the information. The integration ensures that the educational facts are displayed in a format that is both visually appealing and functionally effective, facilitating an enhanced learning experience.

Additionally, the database of virtual characters i.e., the historical database 114 plays a significant role in delivering the educational content and is periodically updated to reflect discoveries and recent historical research. This ongoing update process ensures that the virtual characters remain relevant and accurate in their portrayal of information. By incorporating the latest research and discoveries, the education fact generation system 100 ensures that the virtual characters provide up-to-date and factual content, enhancing the credibility and educational value of the material presented.

The educational fact generation system 100 further includes a feedback module 140 operatively coupled to the online learning platform 102 and is integrated within the educational facts planning module 116. The feedback module 140 plays a crucial role in refining and enhancing the educational experience by collecting detailed feedback from users who interact with the real-time tutors during the online learning session. The feedback module 140 is designed to gather various forms of user input, such as responses, reactions, and engagement metrics after the user has watched the educational videos that include the AI-generated facts. The feedback encompasses a wide range of data points, including user ratings, comments, time spent on each video, and specific interactions with the virtual character or particular facts presented.

By analyzing this feedback, the AI engine 126 can measure the effectiveness of the educational fact in terms of user engagement and learning outcomes. The insights gained from the feedback assist the AI engine 126 in understanding how well the facts align with the educational standards and how impactful they are in capturing and maintaining user interest. This continuous loop of feedback allows the AI engine 126 to adjust and fine-tune the educational facts and the presentation style of the virtual character, ensuring that the content remains relevant, engaging, and educationally effective. Finally, the feedback module 140 contributes to creating a more personalized and impactful learning experience, tailored to the needs and preferences of each user.

Exemplary pseudo-code for programmatic process control integration with the AI engine 126 by the educational fact generation system 100 is given below:

function generateFacts(standards, factDatabase)
{
retrievedData = retrieveData(standards, factDatabase);
alignedFacts = analyzeAlignment(retrievedData, standards);
engagingFacts = evaluateShockValue(alignedFacts);
return engagingFacts;
}

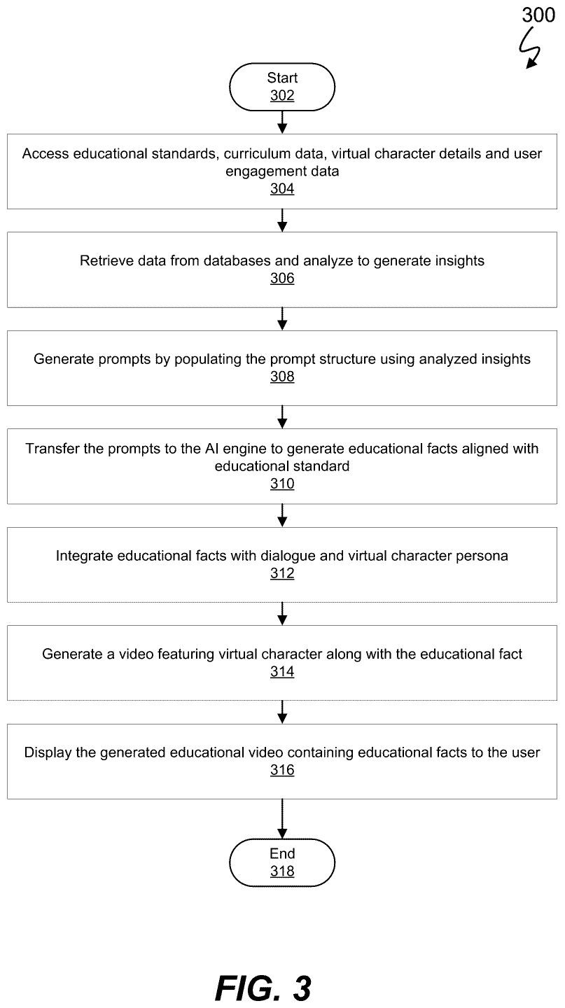

FIG. 3 depicts an exemplary educational video generation process 300 that features a real-time tutor and includes educational facts, which is an embodiment of the educational facts generation process 200 of FIG. 2.

The video generation process 300 features a real-time tutor and includes educational facts that operate through a series of structured steps, to deliver educational facts to the user effectively. The video generation process 300 begins at step 302, where the user accesses the online learning platform 102 to learn various educational topics. The online learning platform 102 serves as the gateway for users to engage with the educational content generated by the educational facts generation system 100.

In step 304, the data collector 118 accesses multiple databases to gather necessary information. The data collector 118 retrieves educational standards, curriculum data, and details of virtual characters from the educational database 110, curriculum database 112, and historical database 114, respectively. Additionally, user engagement data 108 is retrieved from the memory 106 of the online learning platform 102. This comprehensive data collection ensures that the generated educational facts are relevant and in correspondence with the educational standard of the user.

Step 306 involves the retrieval and analysis of the gathered data. The analyzer 120 processes this data to generate valuable insights. These insights are crucial for understanding the educational context and the engagement patterns of the users, enabling the system to tailor the content accordingly. In step 308, the prompt generator 124 uses these insights to create structured prompts by populating the prompt structure with the analyzed data. The prompts effectively guide the AI engine 126 and serve as the foundation for generating educational facts that are engaging and aligned with educational standards.

The video generation process 300 continues with step 310, where the prompts generated by the prompt generator 124 are transferred to the AI engine 126. The AI engine 126 utilizes these prompts to generate educational facts that are in accordance with the specified educational standards. This ensures that the content is not only engaging but also educationally appropriate. Step 312 involves the integration of these educational facts with dialogue and the persona of a virtual character. This step ensures that the educational content is presented coherently and engagingly, with the virtual character acting as a real-time tutor to interact with the user.

In step 314, a video is generated featuring the virtual character alongside the educational facts. The video generator 132, integrated within the AI engine 126, produces this video. The virtual character's movements, facial expressions, and voice are synchronized with the educational content, making the presentation smooth and natural. Finally, step 316 entails displaying the generated educational video to the user. The display module 138 presents this video on the user interface of the online learning platform 102, ensuring that the user can access and engage with the educational content seamlessly.

The video generation process 300 concludes at step 318, marking the end of the educational fact generation system 100.

FIGS. 4 and 5 depict exemplary user interfaces disclosing the educational facts along with the educational video featuring a real-time tutor.

The user interface 400 discloses a real-time tutor 402 along with an educational fact generated by the AI engine 126. The educational fact is in the form of a ‘Did you know’ type educational fact 406. The ‘Did you know’ type educational fact 406 is generated by the fact generator 130, integrated within the AI engine 126. The ‘Did you know’ type educational fact 406 is the educational fact that is generated in correspondence to the educational standard of the user. Although not limited to, the educational facts may include other types of questions as well like, Fill-in-the-Blanks, Truth or Lie, Match the Following, and so on.

Along with the ‘Did you know’ type educational fact 406, a video is generated using the video 132 integrated within the AI engine 126. The generated video features a real-time tutor 402, which is Albert Einstein in the case of the present example. The details of the real-time tutor 402 are mentioned below on the left side, mentioning the name of the real-time tutor 402, i.e., Albert Einstein 404, the theoretical physicist. The real-time tutor 402 is selected in correspondence to the ‘Did you know’ type educational fact 406.

Further, the user can also provide feedback, or ask any question using the chatbot 408. The real-time tutor 402 interacts with the user on a real-time basis.

Similarly, in the case of the user interface 500, a real-time tutor 502 along with an educational fact generated by the AI engine 126 is displayed. The educational fact is in the form of a ‘Did you know’ type educational fact 506. The ‘Did you know’ type educational fact 506 is generated by the fact generator 130, integrated within the AI engine 126. The ‘Did you know’ type educational fact 506 is the educational fact that is generated in correspondence to the educational standard of the user.

Along with the ‘Did you know’ type educational fact 506, a video is generated using the video 132 integrated within the AI engine 126. The generated video features a real-time tutor 502, which is J. Robert Oppenheimer in the case of the present example. The details of the real-time tutor 402 are mentioned below on the left side, mentioning the name of the real-time tutor 502, i.e., J. Robert Oppenheimer 504, the atomic bomber developer. The real-time tutor 502 is selected in correspondence to the ‘Did you know’ type educational fact 506.

The generated video provides details related to the ‘Did you know’ type educational fact 406. For instance, in the case of the user interface 400, the real-time tutor 402, guides the user by stating educational facts like: ‘The double-helix structure of DNA is a master of compact storage. Scientists have capitalized on this by encoding information in the four chemical bases of the DNA. While doing so they are able to store massive amounts of data in a tiny space, just like nature does. Imagine that 1 gm of DNA can store the entire internet's data with room to space.’

The generated video provides details related to the ‘Did you know’ type educational fact 506. For instance, in the case of the user interface 500, the real-time tutor 502, guides the user by stating educational facts like: ‘During World War II, the British army had a fantastic unit called Popski's Private Army, who on occasion used to train animals like rabbits, dogs, and even elephants named tropical to search and dig out enemy pressure activated explosive devices. Some snuffer warriors were even provided with armed jackets.’

The videos provide detailed information about the ‘Did you know’ type educational facts 406 and 506, explained by the real-time tutors 402 and 502. This makes learning more interesting and engaging for the user.

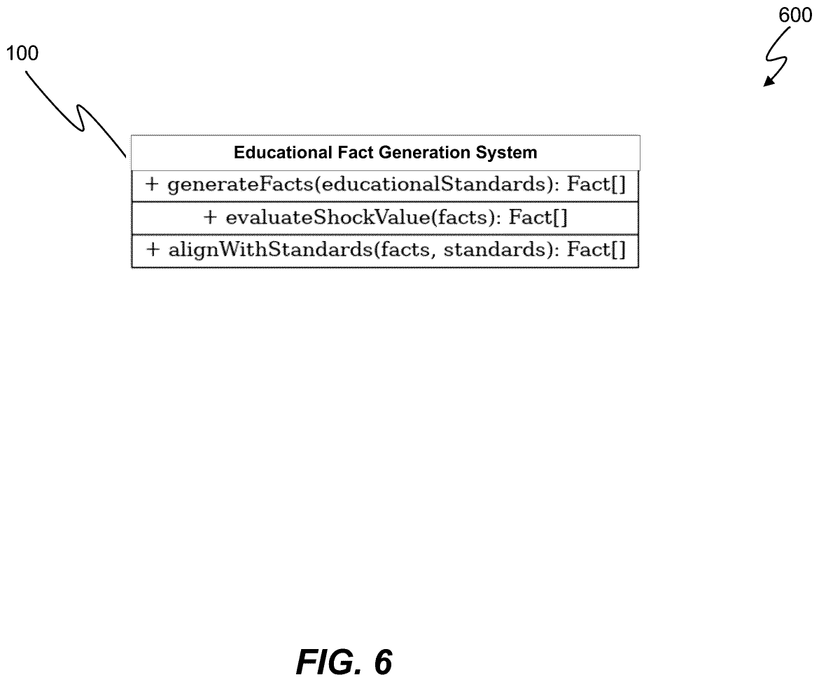

FIG. 6 depicts a data structure 600 for organizing data to generate educational facts based on educational standards and shock value related to the user.

The data structure 600 illustrates the AI-driven educational fact generation system 100 incorporated within a single node named educational fact generation system 100. The AI-driven educational fact generation system 100 identifies the overall purpose and functionality and acts as a title, indicating that the node represents an educational fact generation system 100 designed to generate educational facts using artificial intelligence.

The educational fact generation system 100 node includes 3 main functions namely, generateFacts(educationalStandards), evaluateShockValue(facts), and alignWithStandards(facts, standards). The generateFacts(educationalStandards) function is tasked with generating an array of facts based on provided educational standards. It takes educational standards as input and produces an array of facts that align with these educational standards. The AI engine 126 utilizes relevant information and formulates it into factual statements that are suitable for educational purposes.

The evaluateShockValue(facts) function evaluates the generated facts to assess their shock value. The shock value refers to the potential of these facts to capture and maintain the user's interest and engagement. The array of facts is taken as input and output is provided as an array of facts that have been evaluated and possibly ranked based on their shock value.

The alignWithStandards(facts, standards) function ensures that the generated facts are aligned with the specified educational standards. It takes an array of facts and the educational standards as inputs and outputs an array of facts that conform to the given standards. This aligns the factual content with the educational requirements to ensure relevance and accuracy.

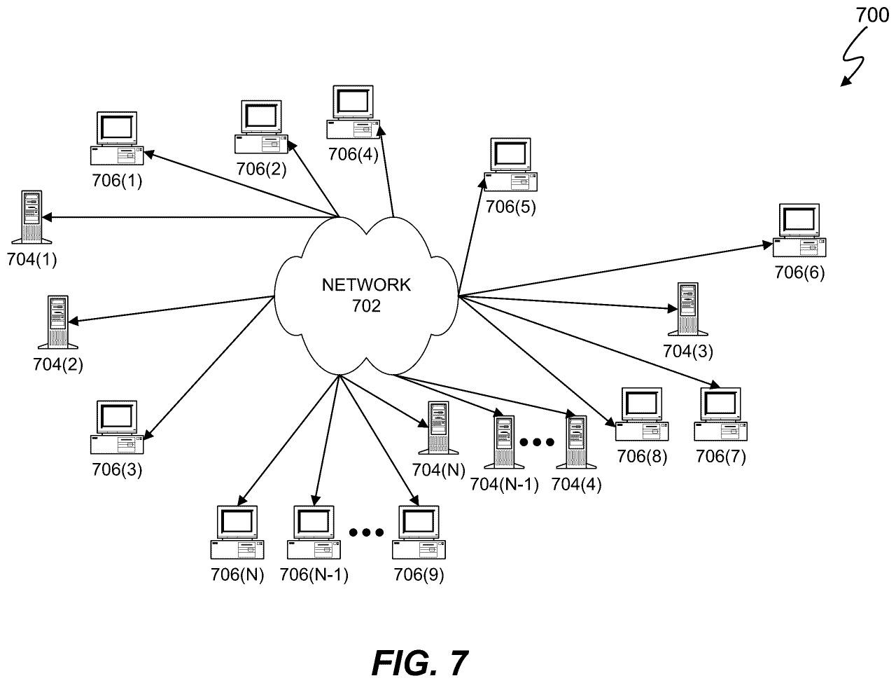

FIG. 7 is a block diagram illustrating a network environment in which an educational facts generation system 100 and process 200 based on the educational standards may be practiced. Network 702 (e.g. a private wide area network (WAN) or the Internet) includes several networked server computer systems 704(1)-(N) that are accessible by client computer systems 706(1)-(N), where N is the number of server computer systems connected to the network. Communication between client computer systems 706(1)-(N) and server computer systems 704(1)-(N) typically occurs over a network, such as a public switched telephone network over asynchronous digital subscriber line (ADSL) telephone lines or high-bandwidth trunks, for example, communications channels providing T1 or OC3 service. Client computer systems 706(1)-(N) typically access server computer systems 704(1)-(N) through a service provider, such as an internet service provider (“ISP”) by executing application-specific software, commonly referred to as a browser, on one of client computer systems 706(1)-(N).

Client computer systems 706(1)-(N) and/or server computer systems 704(1)-(N) are specialized computers programmed to improve conventional computer systems to implement and utilize the educational facts generation system 100 and process 200 based on the educational standards. The type of computer system that can be specially programmed to implement and utilize the educational facts generation system 100 and process 200 based on the educational standards includes a mainframe, a mini-computer, a personal computer system including notebook computers, a wireless, mobile computing device (including personal digital assistants, smartphones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the educational facts generation system 100 and process 200 based on the educational standards can be implemented using code stored in a tangible, non-transient computer-readable medium and executed by one or more processors. In at least one embodiment, the educational facts generation system 100 and process 200 based on the educational standards can be implemented completely in hardware using, for example, logic circuits and other circuits including field programmable gate arrays.

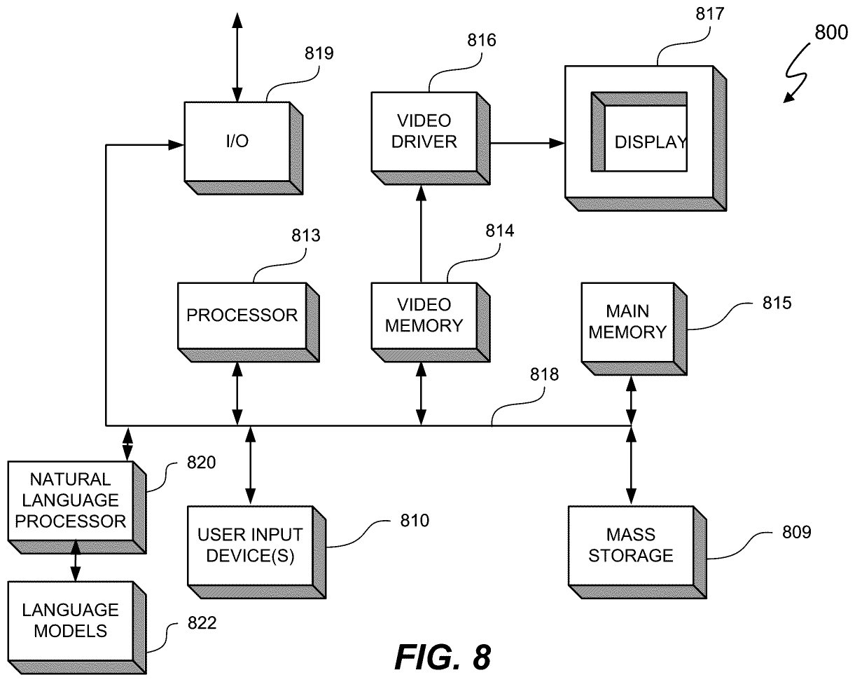

Embodiments of the educational facts generation system 100 and process 200 based on the educational standards can be implemented on a computer system such as a special-purpose, special-programmed computer 800 illustrated in FIG. 8. The input user device(s) 810, such as a keyboard and/or mouse, are coupled to a bi-directional system bus 818. The input user device(s) 810 are for introducing user input to the computer system and communicating that user input to the processor 813. The computer system of FIG. 8 generally also includes a non-transitory video memory 814, non-transitory main memory 815, and non-transitory mass storage 809, all coupled to the bi-directional system bus 818 along with input user device(s) 810 and processor 813. The mass storage 809 may include both fixed and removable media, such as a hard drive, one or more CDs or DVDs, solid state memory including flash memory, and other available mass storage technology. Bus 818 may contain, for example, 32 of 64 address lines for addressing video memory 814 or main memory 815. The system bus 818 also includes, for example, an n-bit data bus for transferring DATA between and among the components, such as CPU 809, main memory 815, video memory 814, and mass storage 809, where “n” is, for example, 32 or 64. Alternatively, multiplex data/address lines may be used instead of separate data and address lines.

I/O device(s) 819 may provide connections to peripheral devices, such as a printer, and may also provide a direct connection to a remote server computer system via a telephone link or to the Internet via an ISP. I/O device(s) 819 may also include a network interface device to provide a direct connection to a remote server computer system via a direct network link to the Internet via a POP (point of presence). Such connection may be made using, for example, wireless techniques, including digital cellular telephone connection, Cellular Digital Packet Data (CDPD) connection, digital satellite data connection, or the like. Examples of I/O devices include modems, sound and video devices, and specialized communication devices such as the aforementioned network interface.

Computer programs and data are generally stored as code in a non-transient computer-readable medium such as flash memory, optical memory, magnetic memory, compact disks, digital versatile disks, and any other type of memory. The computer program is loaded from a memory, such as mass storage 809, into main memory 815 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 813, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 815 consists of dynamic random access memory (DRAM). Video memory 814 is a dual-ported video random access memory. One port of the video memory 814 is coupled to the video amplifier 816. The video amplifier 816 is used to drive the display 817. Video amplifier 816 is well-known in the art and may be implemented by any suitable means. This circuitry converts pixel DATA stored in video memory 814 to a raster signal suitable for use by display 817. Display 817 is a type of monitor suitable for displaying graphic images.

The computer system described above is for purposes of example only. The educational facts generation system 100 and process 200 based on the educational standards may be implemented in any type of computer system or programming or processing environment. It is contemplated that the educational facts generation system 100 and process 200 based on the educational standards might be run on a stand-alone computer system, such as the one described above. The educational facts generation system 100 and process 200 based on the educational standards might also be run from a server computer system that can be accessed by a plurality of client computer systems interconnected over an intranet network. Finally, the educational facts generation system 100 and process 200 based on the educational standards may be run from a server computer system that is accessible to clients over the Internet.

Although embodiments have been described in detail, it should be understood that various changes, substitutions, and alterations can be made herein without departing from the spirit and scope of the invention as defined by the appended claims.

What is claimed is:

1. A method that integrates programmatic control and a guided and constrained Artificial Intelligence (AI) engine to generate educational facts in correspondence to an educational standard of a user using an online learning platform, the method comprises:
executing code using one or more processors of a computer system to cause the computer system to perform operations comprising:
accessing one or more databases to retrieve the educational standard, curriculum data of the user, details of the virtual character, and user engagement data;
analyzing the retrieved educational data, curriculum data, virtual character details, and user engagement data to provide insights for populating a prompt structure;
generating prompts to guide the AI engine by populating the prompt structure based on the analyzed insights;
transferring the prompts to the AI engine to generate educational facts in correspondence to the educational standard;
generating an educational video featuring a virtual character presenting educational facts using deep learning techniques, wherein the educational video is in correspondence to the educational standards of the user;
displaying the generated educational video to the user, wherein the educational video includes the educational facts aligned with the educational standards to engage the user using the online learning platform.

2. The method of claim 1 wherein the educational standards are aligned with national or regional educational requirements, and curriculum data include subject, grade level, and specific curriculum requirements.

3. The method of claim 1 wherein the virtual character is an AI-generated real-time tutor featured in the generated educational video who interacts with the user in real-time.

4. The method of claim 1 wherein the details of the virtual character include the virtual character's biographic information, images, and audio.

5. The method of claim 1 wherein the prompt structure is a structure of the prompts along with the rules and the guidelines provided using prompt engineering technique.

6. The method of claim 1 wherein the user engagement data includes time spent by the user in an online learning session, and user feedback and is determined based on shock value to enhance user interaction and learning.

7. The method of claim 6 wherein the shock value is determined based on the emotional and cognitive response of the user, thereby making the learning more memorable and effective.

8. The method of claim 1 wherein the educational facts aligned with specific educational standards and incorporate a high shock value to engage users effectively.

9. The method of claim 1 for integrating the educational facts along with the educational video further comprises:
combining the educational facts generated by the AI engine with the dialogue scripted for presentation;
incorporating the virtual character's persona, including its personality traits, voice, and appearance, thereby ensuring that the integrated output provides an engaging educational experience.

10. The method of claim 1 wherein the generated video including the educational facts further comprises:
utilizing deep learning techniques, including neural networks with multiple layers, to create realistic videos with animations and voice synthesis;
generating the educational video in which the virtual character presents the educational facts, ensuring that the virtual character's movements, facial expressions, and voice are smooth and natural.

11. The method of claim 1 further comprises:
integrating the educational facts along with the dialogue and the virtual character's persona in the generated video featuring the real-time tutor.

12. The method of claim 1 wherein the generated educational facts are evaluated for factual accuracy and engagement potential before being used in educational videos.

13. The method of claim 1 wherein a feedback is collected from the user who interacts with the educational videos including educational facts.

14. A system that integrates programmatic control and a guided and constrained Artificial Intelligence (AI) engine to generate educational facts in correspondence to an educational standard of a user using an online learning platform comprises:
one or more processors of a computer system; and
a memory, coupled to the one or more processors, storing code that when executed causes the computer system to perform operations comprising:
accessing one or more databases to retrieve the educational standard, curriculum data of the user, details of the virtual character, and user engagement data using a data collector;
analyzing the retrieved educational data, curriculum data, virtual character details, and user engagement data using an analyzer to provide insights for populating a prompt structure;
generating prompts using a prompt generator to guide the AI engine by populating the prompt structure based on the analyzed insights;
transferring the prompts provided by the prompt generator to the AI engine to generate educational facts in correspondence to the educational standard using a fact generator;
generating an educational video featuring a virtual character presenting educational facts using deep learning techniques using a video generator, wherein the educational video is in correspondence to the educational standards of the user;
displaying the generated educational video to the user using a display module, wherein the educational video includes the educational facts aligned with the educational standards to engage the user using the online learning platform.

15. The system of claim 14 wherein the educational data, curriculum data, virtual character details, and user engagement data are retrieved from an educational database, curriculum database, historical database, and memory of the online learning platform respectively.

16. The system of claim 14 wherein the generated educational facts are displayed to the user on a user interface is integrated within the online learning platform.

17. The system of claim 14 wherein the database of virtual characters is periodically updated to include discoveries and recent historical research.

18. The system of claim 14 wherein the video generator allows customization of the appearance and voice of AI-generated virtual characters featured in the video alongside the educational facts to enhance the relatability and engagement of the user.

19. The system of claim 14 further comprises:
a shock value calculator operatively coupled to the AI engine to check the emotional impact of the generated educational facts based on the shock value and adjust the educational facts accordingly to optimize user engagement.

20. The system of claim 13 wherein a feedback module collects feedback from the user who interacts with the educational videos including educational facts.
